(19) United States
(12) Patent Application Publication
(10) Pub. No.: US 2013/0288128 A1
(43) Pub. Date: Oct. 31, 2013

(54) ACTIVE MATERIAL OF NEGATIVE ELECTRODE, TILTED-GRID SUBSTRATE OF NEGATIVE ELECTRODE, NEGATIVE ELECTRODE FOR NICKEL-ZINC BATTERY, AND METHODS FOR PREPARING NEGATIVE ELECTRODE

(71) Applicant: Ruiling Li, Guangdong (CN)

(72) Inventor: Ruiling Li, Guangdong (CN)

(73) Assignee: Guangdong Powerlink Energy Co., Ltd., Guangdong (CN)

(21) Appl. No.: 13/994,678

(22) PCT Filed: Jun. 15, 2012
(86) PCT No.: PCT/CN2012/076969

§ 371 Date: Jun. 14, 2013

(30) Foreign Application Priority Data
Jun. 22, 2011 (CN) 201110169866.1

(51) Int. Cl. H01M 4/74; H01M 4/04

(52) U.S. Cl. CPC H01M 4/74; H01M 4/0404
USPC 429/217; 429/241; 252/182.1; 427/126.4

(57) ABSTRACT

The present invention provides a tilted-grid substrate of a negative electrode for a nickel-zinc battery, including a first zinc foil layer; a copper foil layer compounded on the first zinc foil layer; and a second zinc foil layer compounded on the copper foil layer. The present invention further provides an active material composition of a negative electrode for a nickel-zinc battery, a negative electrode for a nickel-zinc battery, the method for preparing the negative electrode, and a nickel-zinc battery. In the tilted-grid substrate of a negative electrode according to the present invention, the surface of zinc eliminates the needs for plating other metal, avoiding the incorporation of impurities. With the use of the nickel-zinc battery, part of the zinc on the surface of the tilted-grid substrate of the negative electrode can participate in the reaction of forming a current in the battery, reducing the fading speed of the battery capacity; and part of the zinc is oxidized to zinc oxide, acting as a conductor to improve the utilization ratio of the active material of the negative electrode. When the zinc layer on the surface of the substrate of the negative electrode participate in the reaction or is oxidized, the copper foil layer can act as the substrate of the negative electrode, so as to improve the performance of the nickel-zinc battery.

### FIELD OF THE INVENTION

The present invention relates to the technical field of nickel-zinc battery, and in particular, to active material of negative electrode, a tilted-grid substrate of negative electrode, a negative electrode for a nickel-zinc battery, and the method for manufacturing the negative electrode.

### BACKGROUND OF THE INVENTION

With the rapid booming and development of electric vehicle, electronic products, etc., novel electric-chemical energy conversion and storage technologies and devices, such as hydrogen-storing material and metal hydride-nickel storage battery, lithium-ion storage battery, fuel cell, super-capacitor, and the like, are sufficiently developed. Compared with conventional batteries such as nickel-cadmium batteries, lead acid batteries, etc., a nickel-zinc battery has the advantages of high specific energy, large specific power, high open circuit voltage, wide range of operating temperature, capability of charging under large current, free of environmental pollution, and the like, and thus have wide application prospect in the fields such as the power source of electric vehicles, or the energy storing sources of wind energy, solar energy, nuclear energy, and the like.

The negative electrode of a nickel-zinc battery generally includes zinc active material and a substrate, which is one of the key technologies in developing and producing a nickel-zinc battery. A variety of technologies for producing the negative electrode are disclosed in the prior art, mainly including compressing method and slurrying method. The compressing method includes mixing zinc active material and molding material to produce a sheet stock, which is then compounded under pressure with a substrate to form an electrode plate, that is, a rolling-binding electrode technology. The slurrying method includes preparing zinc active material, a binder, and a solvent into a slurry; continuously coating the slurry on a substrate by a coating device, and then drying, rolling, and blanking to provide a negative electrode. The slurrying method is widely used due to the advantages of low production cost, rapid production, low rejection ratio, and free of pollution. However, the negative electrode plate produced by the slurrying method is rigid and difficult to be coiled, and has sharp needle-like substrate metal fibers arranged around it, which tends to pierce the membrane separator to cause short circuit of the battery.

Moreover, it can be known from the above preparing process that the substrate of the negative electrode will affect the loading amount of the zinc active material, and in turn affect the performance of the nickel-zinc battery thus obtained. A variety of negative electrode substrates are disclosed in the prior art, for example, a surface-perforated substrate of pure copper foil, a surface-perforated substrate of copper alloy foil, a pure copper grid substrate, a copper alloy grid substrate, a perforated zinc foil substrate, a zinc grid substrate, a foamed pure copper substrate, a foamed copper alloy substrate, a foamed zinc substrate, etc. Chinese patent No. 200910119935.0 disclosed a copper alloy tilted grid substrate of negative electrode, which can increase the contact area between the zinc active material and the substrate and therefore the loading amount of zinc active material. However, in order to avoid decrease in battery performance due to the corrosion and hydrogen-evolution from the substrate, the substrate of copper alloy material entails a layer of material having high hydrogen evolution overpotential plated on the surface, for example, Zn, Sn, Ag, Pb, Bi or In, etc., which increases the production cost and difficulties of the battery, and tends to incorporate impurities, exacerbating the hydrogen evolution of the negative electrode.

### SUMMARY OF THE INVENTION

Correspondingly, the technical problem to be addressed by the present invention is to provide an active material of a negative electrode for a nickel-zinc battery, a tilted-grid substrate of a negative electrode, a negative electrode, and a method for preparing the negative electrode. The negative electrode for a nickel-zinc battery provided by the present invention can be simply prepared, contains low content of impurities, and can provide the nickel-zinc battery with good performance.

The present invention provides a tilted-grid substrate of a negative electrode for a nickel-zinc battery, including:

a first zinc foil layer;

a copper foil layer compounded on the first zinc foil layer; and

a second zinc foil layer compounded on the copper foil layer.

Preferably, the first zinc foil layer has a thickness of 0.03 mm˜0.07 mm

Preferably, the copper foil layer has a thickness of 0.03 mm˜0.07 mm

Preferably, the second zinc foil layer has a thickness of 0.03 mm˜0.07 mm

Preferably, the tilted-grid substrate includes:

a bottom plate for the substrate of the negative electrode;

protrusions symmetrically arranged on two sides of the bottom plate for the substrate of the negative electrode; and

a groove arranged in the middle of the bottom plate for the substrate of the negative electrode.

Preferably, the protrusions are formed by folding and flattening the two sides of the bottom plate for the substrate of the negative electrode.

In comparison with the prior art, the tilted-grid substrate of the negative electrode for a nickel-zinc battery provided by the present invention includes a first zinc foil layer, a copper foil layer compounded on the first zinc foil layer, and a second zinc foil layer compounded on the copper foil layer. In the tilted-grid substrate of the negative electrode according to the present invention, the surface of zinc eliminates the needs for plating other metal, avoiding the incorporation of impurities. With the use of the nickel-zinc battery, part of the zinc on the surface of the tilted-grid substrate of the negative electrode can participate in the reaction of forming a current in the battery, reducing the fading speed of the battery capacity; and part of the zinc is oxidized to zinc oxide, acting as a conductor to improve the utilization ratio of the active material of the negative electrode. When the zinc layer on the surface of the substrate of the negative electrode participate in the reaction or is oxidized, the copper foil layer can act as the substrate of the negative electrode, so as to improve the performance of the nickel-zinc battery. Moreover, the tilted-grid substrate of the negative electrode provided by the present invention has a mesh structure, in which the active material of the negative electrode can be embedded, so that the deformation of the negative electrode and the migration of the active material of the negative electrode can be inhibited during the use of the battery. At the same time, the mesh structure can increase the contact area between the substrate and the active material of the negative electrode, improve the utilization ratio of the active material of the negative electrode, and reduce the current density ratio on the electrode surface area, thereby delaying the deactivation of the negative electrode and improving the operating effect of the nickel-zinc battery under high operating current.

The present invention further provides an active material composition of a negative electrode for a nickel-zinc battery, including:

40 wt %˜60 wt % ZnO;

5 wt %˜10 wt % Zn;

1.5 wt %˜3.5 wt % Zn(OH)₂;

0.5 wt %˜2 wt % Ca(OH)₂;

0.5 wt %˜3 wt % Bi₂O₃;

0.001 wt %˜0.02 wt % In(OH)₂;

20 wt %˜30 wt % binder; and

5 wt %˜10 wt % additive.

Preferably, the binder includes water, polyvinyl alcohol, and hydroxypropyl methyl cellulose by a mass ratio of (90˜95):(3˜5):(2˜5).

Preferably, the additive includes nylon short fibers, polytetrafluoroethylene emulsion, sodium alkyl benzene sulfonate, Na₂HPO₄ and water by a mass ratio of (0.05˜0.3):(3˜7):(0.01˜0.05):(0.1˜0.3):(1˜4).

The nickel-zinc battery adopting the active material composition of the negative electrode provided by the present invention has the advantages of slow capacity fading speed, long cycling life, small internal resistance, stable performance, and the like.

The present invention further provides a negative electrode for a nickel-zinc battery, including the substrate of the negative electrode according to the above technical solution, and the active material composition of the negative electrode according to the above technical solution, the active material composition being coated on the substrate of the negative electrode.

Preferably, the negative electrode for the nickel-zinc battery has a cutting surface without being coated with the active material composition, and the surface symmetric to the cutting surface is soaked by a glue solution including Al₂O₃, MgO, polyvinylidene fluoride emulsion, styrene butadiene rubber emulsion, polyvinyl alcohol and water.

Preferably, the negative electrode for the nickel-zinc battery has several crossed shallow grooves on the surface thereof.

The present invention further provides a method for preparing a negative electrode for a nickel-zinc electrode, includes the steps of:

pretreating two opposite sides of the substrate of the negative electrode prepared according to the above technical solution in Al₂O₃ glue solution which includes Al₂O₃, polyvinyl alcohol, and water;

coating the active material composition of the negative electrode according to the above technical solution on the pretreated substrate of the negative electrode, drying and rolling the substrate, and cutting the substrate along the symmetry axis of the two pretreated sides to provide a negative electrode semi-finished product; and

soaking a surface symmetrical to the cutting surface of the negative electrode semi-finished product in a glue solution to provide the negative electrode for the nickel-zinc battery, the glue solution including Al₂O₃, MgO, Polyvinylidene fluoride emulsion, styrene butadiene rubber emulsion, polyvinyl alcohol, and water.

The present invention further provides a nickel-zinc battery, including the negative electrode according to the above technical solution, or the negative electrode prepared by the method according to the above technical solution.

The negative electrode provide by the present invention is simple in structure and preparation process. The treatments made to the four edges of the negative electrode plate can prevent zinc from growing outward, and avoid the failure of the battery. In addition, the cutting surface, which is not coated with the active material of the negative electrode, of the negative electrode plate provided by the present invention can serve as the channel for conducting and diffusing a current, thereby preventing the plate from deforming due to the large amount of heat produced when the current passes, and effectively inhibiting zinc from forming dendrites at a certain conductive point, providing stable and reliable battery performance. The cylindrical nickel-zinc batteries assembled by the negative electrode provided by the present invention, a nickel positive electrode, a membrane, and electrolyte are tested for the performance thereof. The results show that the nickel-zinc batteries provided by the present invention have lower internal resistance, slower capacity fading speed and longer cycling life.

### BRIEF DESCRIPTION OF THE DRAWINGS

FIG. 1 is the schematically sectional structural view of the tilted-grid substrate of negative electrode provided in one example of the present invention;

FIG. 2 is the schematically top structural view of the tilted-grid substrate of negative electrode provided in the example of the present invention;

FIG. 3 is the schematically structural view of the tilted-grid substrate of negative electrode provided in the example of the present invention;

FIG. 4 is the result of the cycling performance test for the nickel-zinc battery provided by example 7 of the present invention; and

FIG. 5 is the result of the cycling performance test for the nickel-zinc battery provided by example 8 of the present invention.

### DETAILED DESCRIPTION

The present invention provides a tilted-grid substrate of a negative electrode for a nickel-zinc battery, including:

a first zinc foil layer;

a copper foil layer compounded on the first zinc foil layer; and

a second zinc foil layer compounded on the copper foil layer.

The negative electrode substrate provided by the present invention is a tilted-grid substrate, which is of metal material in a structure of zinc foil/copper foil/zinc foil.

The tilted-grid substrate of the negative electrode includes a first zinc foil layer made of pure zinc foil, preferably 0# zinc foil. The first zinc foil layer has a thickness of preferably 0.03 mm˜0.07 mm, and more preferably 0.05 mm

A copper foil layer made of pure copper, preferably T2 pure copper, is compounded on the first zinc foil layer. The copper foil layer has a thickness of preferably 0.03 mm˜0.07 mm, and more preferably 0.05 mm.

A second zinc foil layer made of pure zinc foil, preferably 0# zinc foil, is compounded on the copper foil layer. The second zinc foil layer has a thickness of preferably 0.03 mm˜0.07 mm, and more preferably 0.05 mm.

The tilted-grid substrate of the negative electrode provided by the present invention adopts a metal material having a structure of aluminum foil/copper foil/aluminum foil. Reference is made to FIG. 1, which shows the schematically sectional structural view of the tilted-grid substrate of the negative electrode provided in one example of the present invention. The substrate includes a first aluminum foil layer 11, a second copper foil layer 12 compounded on the first aluminum foil layer 11, and a second aluminum foil layer 11 compounded on the copper foil layer 12.

The tilted-grid substrate of the negative electrode provided by the present invention has tilted-grid structure. Reference is made to FIG. 2, which shows the schematically top structural view of the tilted-grid substrate of the negative electrode provided in the example of the present invention. The tilted-grid substrate is in a tilted-grid structure and has an areal density of preferably 260 g/m²˜600 g/m², and more preferably 300 g/m²˜500 g/m².

The shape of the tilted-grid substrate of the negative electrode is not particularly limited in the present invention, and can be any of the shapes for the substrate of the negative electrode known by those skilled in the art. The substrate preferably has the following shape, including:

a bottom plate for the substrate of the negative electrode;

protrusions symmetrically arranged on two sides of the bottom plate for the substrate of the negative electrode; and

a groove arranged in the middle of the bottom plate for the substrate of the negative electrode.

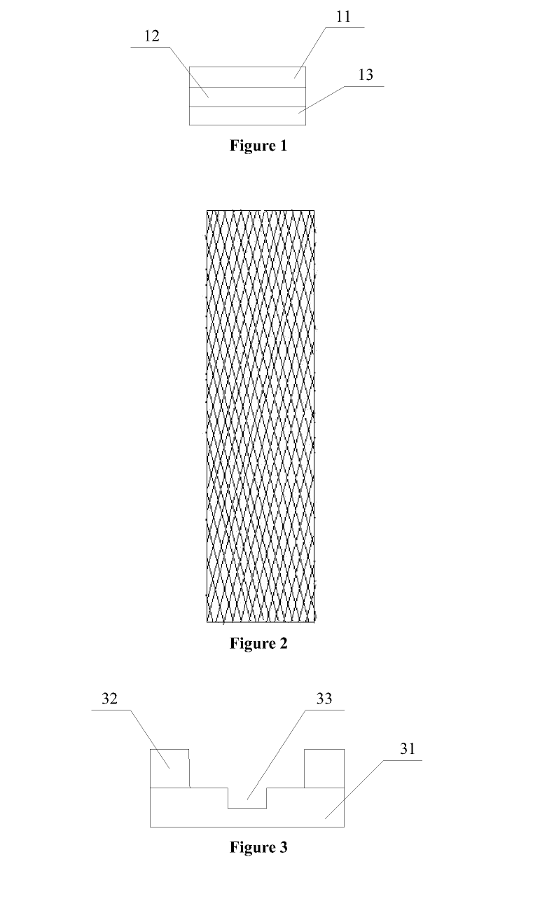

Reference is made to FIG. 3, which shows the schematically structural view of the tilted-grid substrate of a negative electrode provided in the example of the present invention. The substrate includes a bottom plate 31 for the substrate of the negative electrode, protrusions 32 formed by folding and flattening the two sides of the bottom plate for the substrate of the negative electrode, and a groove 33 arranged on the bottom plate for the substrate of the negative electrode.

The bottom plate 31 for the substrate of the negative electrode adopts composite metal plate. In order to decrease the influence of the metal fibers on the electrode, the two sides of the bottom plate 31 for the substrate of the negative electrode are folded and flattened to form protrusions 32, which have a width of preferably 3 mm˜12 mm, and more preferably 5 mm˜10 mm

For the purpose of increasing the contact area between the active material and the substrate of the negative electrode, the groove can be pressed in the middle of the bottom plate 31 for the substrate of the negative electrode. The groove has a width of preferably 3 mm˜12 mm, and more preferably 5 mm˜10 mm; and a depth of preferably 0.1 mm˜0.3 mm, and more preferably 0.15 mm˜0.25 mm

The tilted-grid substrate of the negative electrode provided by the present invention is preferably prepared by the following steps:

the first zinc foil, the copper foil, and the second zinc foil are respectively subjected to surface degreasing, derusting, drying, and compounding in a metal laminator to provide a compounded metal tape having the structure of the first zinc foil layer/the copper foil layer/the second zinc foil layer;

the compounded metal tape is punched to provide a tilted-grid metal tape; and

the tilted-grid metal tape is processed to provide the tilted-grid substrate of the negative electrode.

Using a zinc foil tape and a copper foil tape as the raw material, the present invention first subjects the surfaces of the zinc foil tape and the copper foil tape to degreasing, derusting, cleaning, and drying, which are treatments well known to those skilled in the art, and then compounds them in a metal laminator in the order of zinc foil/copper foil/zinc foil, to provide a compounded metal tape having a structure of first zinc foil layer/copper foil layer/second zinc foil layer. In the present invention, the metal laminator is a metal compounding machine having a heating device and a rolling device, in which the first zinc foil, the copper foil, and the second zinc foil are compounded under heating and rolling to provide the compounded metal tape. The compounding is preferably performed in nitrogen so as to prevent the surface of the metal from being oxidized. The temperature for compounding is preferably 400° C.˜500° C., and more preferably 400° C.450° C.

Upon compounding, the compounded metal tape is punched in a metal cutting machine to provide the tilted-grid metal tape. In the present invention, the metal cutting device refers to a machine having the functions of punching and draw-cutting so that the metal can be processed into grid structure. The tilted-grid metal tape has an areal density of preferably 260 g/m²˜600 g/m², and more preferably 300 g/m²˜500 g/m².

The tilted-grid metal tape is processed according to the desired shape for the substrate of the negative electrode to provide the tilted-grid substrate of the negative electrode. For example, the tilted-grid substrate of the negative electrode shown in FIG. 3 can be obtained by the following steps:

The two opposite edges of the tilted-grid metal tape are symmetrically folded toward the middle, and flattened to form protrusions having a width of preferably 3 mm˜12 mm, and more preferably 5 mm˜10 mm.

A groove is pressed in the middle of the tilted-grid metal tape, which has a width of preferably 3 mm˜12 mm, and more preferably 5 mm˜10 mm; and a depth of preferably 0.1 mm˜0.3 mm, and more preferably 0.15 mm˜0.25 mm

In the tilted-grid substrate of the negative electrode according to the present invention, the surface of zinc eliminates the needs for plating other metal, avoiding the incorporation of impurities. With the use of the nickel-zinc battery, part of the zinc on the surface of the tilted-grid substrate in the negative electrode can participate in the reaction of forming a current in the battery, reducing the fading speed of the battery capacity; and part of the zinc is oxidized to zinc oxide, acting as a conductor to improve the utilization ratio of the active material in the negative electrode. When the zinc layer on the surface of the negative electrode substrate participate in the reaction or is oxidized, the copper foil layer can act as the negative electrode substrate, so as to improve the performance of the nickel-zinc battery. Moreover, the tilted-grid substrate of the negative electrode provided by the present invention has a mesh structure, in which the active material of the negative electrode can be embedded, so that the deformation of the negative electrode and the migration of the active material in the negative electrode can be inhibited during the use of the battery. At the same time, the mesh structure can increase the contact area between the substrate ad the active material of the negative electrode, improve the utilization ratio of the active material of the negative electrode, and reduce current density ratio of the electrode surface area, thereby delaying the deactivation of the negative electrode and improving the operating effect of the nickel-zinc battery under high operating current.

The present invention further provides an active material composition of a negative electrode for a nickel-zinc battery, including:

40 wt %˜60 wt % ZnO;

5 wt %˜10 wt % Zn;

1.5 wt %˜3.5 wt % Zn(OH)₂;

0.5 wt %˜2 wt % Ca(OH)₂;

0.5 wt %˜3 wt % Bi₂O₃;

0.001 wt %˜0.02 wt % In(OH)₂;

20 wt %˜30 wt % binder; and

5 wt %˜10 wt % additive.

The active material composition of the negative electrode for a nickel-zinc battery provided by the present invention includes zinc oxide, which has a content of 40 wt %˜60 wt %, and more preferably 45 wt %˜55 wt %. The particles size of the zinc oxide is not particularly limited in the present invention, and the zinc oxide used in nickel-zinc battery known by those skilled in the art is usable.

The active material composition of the negative electrode for a nickel-zinc battery further includes Zn powder, which has a content of 5 wt %˜10 wt %, and more preferably 6 wt %˜8 wt %. The Zn is preferably nano-Zn, which has a particle size of preferably 100 nm˜500 nm

The active material composition of the negative electrode for a nickel-zinc battery further includes Zn(OH)₂, which has a content of 1.5 wt %˜3.5 wt %, and more preferably 2 wt %˜3 wt %.

The active material composition of the negative electrode for a nickel-zinc battery further includes Ca(OH)₂, which has a content of 0.5 wt %˜2 wt %, and preferably 1 wt %˜1.5 wt %. The Ca(OH)₂ can form calcium salt and reduce the deformation of the negative electrode.

The active material composition of the negative electrode for a nickel-zinc battery further includes Bi₂O₃, which has a content of 0.5 wt %˜3 wt %, and preferably 1 wt %˜2 wt %. The Bi₂O₃ has relatively high hydrogen evolution overpotential, and thus can decrease the corrosion to the electrode.

The active material composition of the negative electrode for a nickel-zinc battery further includes In(OH)₂, which has a content of 0.001 wt %˜0.02 wt %, and preferably 0.005 wt %˜0.01 wt %. The In(OH)₂ has a relatively high hydrogen evolution overpotential, and thus can decrease the corrosion to the electrode, thereby reducing the deformation of the electrode.

The active material composition of the negative electrode for a nickel-zinc battery further includes a binder, which has a content of 20 wt %˜30 wt %, and preferably 25 wt %˜29 wt %. The binder includes, but not limited to polyvinyl alcohol (PVA), carboxymethyl cellulose (CMC), and hydroxypropyl methyl cellulose (HPMC). In the present invention, the binder preferably includes water, polyvinyl alcohol, and hydroxypropyl methyl cellulose by a mass ratio of preferably (90˜95):(3˜5):(2˜5), and more preferably (90˜95):(3˜5):(2˜5).

The active material composition of the negative electrode for a nickel-zinc battery further includes an additive, which has a content of 5 wt %˜10 wt %, and preferably 6 wt %˜8 wt %. The additive serves to prevent the electrode from corroding, delay and inhibit the deformation of the electrode, and improve the performance of the nickel-zinc battery. In the present invention, the additive preferably includes nylon short fibers, polytetrafluoroethylene emulsion, sodium alkyl benzene sulfonate, Na₂HPO₄ and water by a mass ratio of preferably (0.05˜0.3):(3˜7):(0.01˜0.05):(0.1˜0.3):(1˜4), and more preferably (0.1˜0.2):(4˜5):(0.02˜0.04):(0.15˜0.25):(2˜3).

The active material of the negative electrode is preferably prepared by the following steps:

Mixing the binder and the additive, and agitating for 45 min; adding Zn powder, and agitating for 15 min; adding calcium hydroxide, zinc hydroxide, and water, and agitating for 3 min; adding In(OH)₂, and agitating for 30 min; adding Bi₂O₃, and agitating for 5 min; adding ZnO, and agitating for 1.5 h to provide a slurry of the active material composition of the negative electrode.

When the binder includes water, polyvinyl alcohol and hydroxypropyl emthylcellulose, and the additive includes nylon short fibers, polytetrafluoroethylene emulsion, sodium alkyl benzene sulfonate, Na₂HPO₄ and water, the active material of the negative electrode is preferably prepared by the following steps:

firstly, heating the water bath to 60° C., adding olyvinyl alcohol and hydroxypropyl emthylcellulose, and performing agitation for 4 h to provide a binder;

adding nylon short fibers to the binder, and agitating for 45 min;

adding Zn, and agitating for 15 min;

adding calcium hydroxide, zinc hydroxide, and water, and agitating for 3 min;

adding In(OH)₂, and agitating for 30 min;

adding Bi₂O₃, and agitating for 5 min;

adding polytetrafluoroethylene emulsion (PTFE) having a mass concentration of 60%, and agitating for 5 min;

adding sodium dodecylbenzene sulfonate (SDBS), and agitating for 5 min;

adding Na₂HPO₄, and agitating for 5 min; and

finally, adding ZnO, and agitating for 1.5 h to provide a slurry of the active material composition of the negative electrode.

In the above preparing process, the vacuum pressure used during agitating is preferably −0.2 MPa.

When the active material composition of the negative electrode provided by the present invention is used in a nickel-zinc battery, it provides the battery with the advantages of slow capacity-fading speed, long cycling life, low internal resistance, stable performance, and the like.

The present invention further provides a negative electrode for a nickel-zinc battery, including the substrate of the negative electrode and the active material composition of the negative electrode stated in the above technical solutions, in which the active material composition of the negative electrode is coated on the substrate of the negative electrode.

In the negative electrode plate, a conductive wire is often welded on the plate. However, the welding point at which the conductive wire is welded will be concentrated with large amount of heat due to the concentrated current, resulting in the earlier reduction and accumulation of zinc and in turn the breaking of the membrane separator. For avoiding such breaking of the membrane separator, the present invention provides a negative electrode for a nickel-zinc battery, which has a cutting surface, i.e., a metal surface, without being coated with the active material composition of the negative electrode, and thus can diffuse and conduct the current, so as to avoid the concentration of the current.

For the purpose of avoiding the falling off of the negative electrode plate during charging/discharging process of the nickel-zinc battery due to the swelling of the plate, the surface symmetric to the cutting surface of the nickel-zinc battery provided in the present invention is preferably soaked in a glue solution, which preferably includes Al₂O₃, MgO, polyvinylidene fluoride emulsion, butadiene styrene rubber emulsion, polyvinyl alcohol, and water.

For the purpose of improving the diffusing speed of oxygen at the surface of the negative electrode, it is preferred that the surface of negative electrode for the nickel-zinc battery has several crossed shallow grooves, which can increase the diffusing speed of protons in the solid phase of the negative electrode, thereby improving the charging/discharging efficiency of the nickel-zinc battery.

The present invention further provides a method for preparing the negative electrode of a nickel-zinc battery, including the steps of:

pretreating two opposite sides of the substrate of the negative electrode according to the above technical solution in Al₂O₃ glue solution, the glue solution including Al₂O₃, polyvinyl alcohol, and water;

coating the active material composition of the negative electrode according to the above technical solution on the pretreated substrate, drying and rolling the substrate, and cutting the substrate along the symmetric axis of the two pretreated sides to provide a negative electrode semi-finished product;

soaking a surface symmetric to the cutting surface of the negative electrode semi-finished product in a glue solution including Al₂O₃, MgO, polyvinylidene fluoride emulsion, butadiene styrene rubber emulsion, polyvinyl alcohol, and water to provide the negative electrode for the nickel-zinc battery.

Firstly, the two opposite sides of the substrate of the negative electrode are pretreated in Al₂O₃ glue solution by the following steps:

heating PVA and water, which have a mass ratio of preferably 5˜10:95˜90 and more preferably 6:94, to 55° C.˜65° C., preferably 60° C., and agitating to provide a glue;

adding Al₂O₃ to the glue and uniformly agitating to provide Al₂O₃ glue solution, in which the glue and the Al₂O₃ have a mass ratio of preferably 95˜90:5˜10, and more preferably 97:3; the Al₂O₃ is preferably δ-Al₂O₃, which has a particle size of preferably 150 mesh to 200 mesh, and more preferably 170 mesh;

soaking the two opposite sides of the substrate of the negative electrode according to the above technical solution in the Al₂O₃ glue solution for 2 min˜5 min, preferably 3 min, and then drying the substrate of the negative electrode in a drier at 60° C. to provide a pretreated negative electrode substrate.

When the substrate of the negative electrode obtains the structure as shown in FIG. 3, the two sides of the substrate, which have protrusions thereon, is pretreated. Since Al₂O₃ has a poor conductivity, soaking the two sides having protrusions of the substrate can reduce the conductivity of the two sides, thereby reducing the current at the edges and in turn the deformation of the negative electrode of the battery.

The slurry of the active material composition of the negative electrode according to the above technical solution is coated on the pretreated negative electrode substrate by the following steps:

pouring the slurry of the active material composition of the negative electrode into a slurry tank while under an agitation at 3 rad/s;

soaking the substrate of the negative electrode in the slurry tank so that the slurry is coated on the surface of the substrate;

removing excessive slurry from the surface of the substrate of the negative electrode, preferably by using a squeegee mould to remove the excessive slurry from the surface of the substrate of the negative electrode.

The substrate of the negative electrode coated with the slurry is subjected to drying and rolling known by those skilled in the art, and then is cut along the symmetric axis of the two treated sides to provide a negative electrode semi-finished product having a cutting surface without being coated with the negative electrode active material. In the present invention, the substrate of the negative electrode coated with the slurry is preferably dried in a drier, which preferably has five drying zones. The dried substrate coated with the slurry is rolled to a certain thickness, and cut by an automatic slicer along the symmetric axis of the two treated sides to provide a negative electrode semi-finished product. When the substrate of the negative electrode obtains the structure shown in FIG. 3, it is cut along the length direction of the groove to provide a negative electrode semi-finished product having a cutting surface without being coated with negative electrode active material.

The surface symmetric to the cutting surface of the negative electrode semi-finished product is soaked in a glue solution by the following steps:

heating PVA and water, which have a mass ratio of preferably 5˜10:95˜90 and more preferably 6:94, to 60° C., and agitating to provide a glue;

mixing the glue, Al₂O₃, MgO, PTFE emulsion having a mass concentration of 60%, and SBR emulsion by a mass ratio of preferably 85˜95:1˜2:0.5˜1:1.5˜2, and more preferably 91:1.33:0.97:5:1.7, to provide a glue solution; and

soaking the surface symmetric to the cutting surface of the negative electrode semi-finished product in the glue solution to provide a negative electrode for a nickel-zinc battery.

When the substrate of the negative electrode has the structure shown in FIG. 3, the side having protrusions is the surface symmetric to the cutting surface. Soaking the side having protrusions in the glue solution can provide good binding effect, and prevent the edges from falling off due to the swelling of the plate during charging/discharging process, thereby increasing the service life of the negative electrode.

Before the surface symmetric to the cutting surface of the negative electrode semi-finished product is soaked in the glue solution, the two other sides of the negative electrode semi-finished product are preferably wrapped with a membrane separator to protect the negative electrode.

In the negative electrode for a nickel-zinc battery prepared by the above method, the cutting surface without being coated with negative electrode active material can serve as the channel for diffusing and conducting the current in the negative electrode plate.

For the purpose of improving the diffusing speed of oxygen at the surface of the negative electrode, it is preferred that the surface of the negative electrode for the nickel-zinc battery is pressed with several crossed shallow grooves, which can increase the diffusing speed of protons in the solid phase of the negative electrode, thereby improving the charging/discharging efficiency of the nickel-zinc battery. In the present invention, the surface of the negative electrode for the nickel-zinc battery is preferably rolled by a bearing having bulged stripes.

The negative electrode provided by the present invention has the advantages of simple structure and simple preparing process. The treatment performed on the four edges of the negative electrode plate prevents zinc from growing outward, and thus avoids the failure of the battery. Furthermore, the cutting surface of the negative electrode plate provided by the present invention, which is not coated with negative electrode active material, can serve as the channel for guiding and diffusing a current, so as to prevent the plate from being deformed due to high amount of heat produced during the passing of current. It can also effectively inhibit zinc from grow dendrites at a certain conductive point, improving the reliability and stability of the battery.

The negative electrode provided by the present invention, a nickel positive electrode, and electrolyte are assembled to a cylindrical nickel-zinc battery. Various nickel-zinc batteries are tested for the performance. The results showed that the nickel-zinc battery provided by the present invention has lower internal resistance, slower capacity fading, and longer cycling life.

The present invention also provides a nickel-zinc battery, including the negative electrode for the nickel-zinc battery according to the above technical solution, or the negative electrode for the nickel-zinc battery prepared by the method according to the above technical solution.

The nickel-zinc battery includes a core and an electrolyte solution sealed in a battery case. The core includes a negative electrode, a positive electrode, and a membrane separator disposed between the negative electrode and the positive electrode.

In the present invention, the negative electrode for the nickel-zinc battery is the negative electrode according to the above technical solution, or the negative electrode prepared by the method according to the above technical solution.

The positive electrode for the nickel-zinc battery is a nickel positive electrode well known by those skilled in the art, and can be formed by, for example, mixing spherical nickel hydroxide, cobalt monoxide, conductive carbon black, polytetrafluoroethylene, carboxymethyl cellulose and water to provide a slurry, coating the slurry on a foamed nickel having a current-conducting tape, and drying, rolling and cutting the foamed nickel.

The membrane separator is the membrane separator well known by those skilled in the art, and can be, for example, a composite membrane separator formed by welding or binding polypropylene felt, vinylon felt, or nylon felt with wettable, microporous polyolefin membrane.

The electrolyte solution can be the aqueous solution of one or more of sodium hydroxide, potassium hydroxide, and lithium hydroxide.

In the present invention, the method for preparing the nickel-zinc battery is not particularly limited. A cylindrical or square nickel-zinc battery can be formed by coiling and assembling the nickel positive electrode, the negative electrode, and the membrane separator into a core, and then sealing the core together with the electrolyte solution in a battery case.

The nickel-zinc battery provided by the present invention has lower internal resistance, slower capacity fading speed, and longer cycling life.

For better explaining the present invention, the active material of the negative electrode for the nickel-zinc battery, the tilted-grid substrate of the negative electrode, the negative electrode and the method for preparing the negative electrode will be described in details in combination with the following examples.

### Example 1

### Preparation of the Active Material Slurry for the Negative Electrode of the Nickel-Zinc Battery

Firstly heating the water bath to 60° C., adding PVA and HPMC thereto so that the water, PVA and HPMC have a mass ratio of 93:4.5:2.5, and performing agitation for 4 h to provide a binder.

adding 0.12 g nylon short fibers to 29 g binder, and agitating for 45 min; adding 7.3 g Zn, and agitating for 15 min; adding 5.91 g mixture of calcium hydroxide, zinc hydroxide, and water having a mass ratio of 1:2:2, and agitating for 3 min; adding 0.008 g In(OH)₂, and agitating for 30 min; adding 1.35 g Bi₂O₃, and agitating for 5 min; adding 6.1 g polytetrafluoroethylene (PTFE) emulsion having a mass concentration of 60%, and agitating for 5 min; adding 0.0372 g Sodium dodecylbenzene sulfonate (SDBS), and agitating for 5 min; adding 0.19 g Na₂HPO₄, and agitating for 5 min; and finally, adding 50 g ZnO, and agitating for 1.5 h to provide a slurry of the active material composition of the negative electrode.

The above agitations are all performed under a vacuum pressure of −0.2 MPa, during which the agitator is taken out every 30 min, and continue to word after the slurry attached on the agitating vessel is removed.

### Example 2

### Preparation of the Substrate of the Negative Electrode

A 0.05 mm-thick first 0# zinc foil tape, a 0.05 mm-thick T2 pure copper foil tape, and a 0.05 mm-thick second 0# zinc foil tape are separately subjected to surface degreasing, derusting, and drying, and are then compounded in a closed metal compounding machine filled with nitrogen at 407° C. to provide a compounded metal tape having a structure of first zinc foil/copper foil/second zinc foil;

punching and draw-cutting the compounded metal tape in a metal punching device to a tilted-grid metal tape having an areal density of 300 g/m²;

folding and flattening the 3 mm-wide edges at two sides of the tilted-grid metal tape toward the middle to provide a tilted-grid metal tape having protrusions; and

pressing a 3 mm-wide and 0.1 mm-deep groove in the middle of the tilted-grid metal tape to provide the substrate of the negative electrode.

### Example 3

### Preparation of the Negative Electrode for a Nickel-Zinc Battery

Heating PVA and water, which have a mass ratio of 6:94, to 60° C., and agitating to provide a glue; adding 3 g δ-Al₂O₃ of 170 mesh to 97 g glue, and uniformly agitating to provide Al₂O₃ glue solution; and soaking the two sides of the substrate, which have protrusions as prepared in example 2, in the Al₂O₃ glue solution for 3 min, and drying the substrate of the negative electrode in a drier at 60° C. to provide a pretreated substrate of the negative electrode;

pouring the slurry of the active material composition of the negative electrode prepared in example 1 into a slurry tank while under agitating at 3 rad/s; soaking the pretreated substrate of the negative electrode in the slurry tank so that the slurry is coated on the surface of the substrate of the negative electrode; removing excessive slurry from the surface of the substrate of the negative electrode by a squeegee mould, drying the substrate of the negative electrode, rolling the same by a rolling machine, and cutting the substrate of the negative electrode along the length direction of the groove thereon to provide a negative electrode semi-finished product having a cutting surface without being coated with the active material of the negative electrode;

heating PVA and water, which are in a mass ratio of 6:94, to 60° C. and agitating to provide a glue; mixing the glue, Al₂O₃, MgO, PTFE emulsion having a mass concentration of 60%, and SBR emulsion, in a mass ratio of 91:1.33:0.97:1.7 to provide a glue solution; wrapping the two sides adjacent to the cutting surface with a membrane separator for a lithium battery, and soaking the side opposite to the cutting surface in the glue solution to provide the negative electrode; and

rolling the soaked surface of the negative electrode with a bearing having bulged stripes to provide the negative electrode having crossed shallow grooves on the surface thereof.

### Examples 4-5

A negative electrode for a nickel-zinc battery is prepared according to the method in example 3, except for using a composition of the slurry of the negative electrode active material listed in table 1 below, which shows the components and ratio of the active material composition of the negative electrode for a nickel-zinc battery.

TABLE 1
components and ratio of the active material composition of the negative electrode for a
nickel-zinc battery provided in examples 4-5 of the present invention

| | | | | Calcium | | | | | | |
|---|---|---|---|---|---|---|---|---|---|---|
| | | Nylon | | hydroxide, | | | | | | |
| | | short | | zinc | | | PTFE | | | |
| | binder | fiber | Zn | hydroxide, | In(OH)₂ | Bi₂O₃ | emulsion | SDBS | Na₂HPO₄ | ZnO |
| examples | (g) | (g) | (g) | and water(g) | (g) | (g) | (g) | (g) | (g) | (g) |
| 4 | 28.5 | 0.12 | 8 | 5.90 | 0.008 | 1.35 | 6.1 | 0.0372 | 0.15 | 50 |
| 5 | 29 | 0.10 | 9 | 4.90 | 0.008 | 1.35 | 6.1 | 0.0372 | 0.15 | 48 |

### Comparative Example 1

A negative electrode for a nickel-zinc battery is prepared according to the method in example 3, except for using a 0.15 mm-thick copper foil as the substrate of the negative electrode, on which a Zn layer is plated.

### Example 6

The negative electrodes prepared in examples 3-5 and comparative example 1, and nickel positive electrodes, with polypropylene membrane separators disposed therebetween, are respectively wound in a winding machine for multiple loops to form a core, which is then accommodated in a SC type steel battery case, and subjected to spot welding, notching, filling with NaOH electrolyte solution, and sealing to provide a cylindrical nickel-zinc battery. The nickel positive electrode is prepared by mixing 386 g spherical nickel hydroxide, 28 g cobalt monoxide, 44 g conductive carbon black, 12 g polytetrafluoroethylene emulsion, 0.8 g carboxymethyl cellulose and 208 g deionized water to provide a slurry, coating the slurry on a foamed nickel welded with a current conducting tape, and drying, rolling and cutting the foamed nickel.

The nickel-zinc batteries are tested for their performance, and the results are shown in table 2, which shows the performance parameters of the nickel-zinc batteries provided in the examples of the present invention.

TABLE 2
performance parameters of the nickel-zinc batteries provided in the
examples of the present invention

| | | | Charging | | Discharging | | |
|---|---|---|---|---|---|---|---|
| | | Height of | internal | Discharging | internal | Height after | Height |
| | | the battery | resistance | capacity | resistance | formation | difference |
| examples | | (mm) | (mΩ) | (mAh) | (mΩ) | (mm) | (mm) |
| 1 | 1 | 42.25 | 4.3 | 2010 | 6.2 | 42.26 | 0.01 |
| | 2 | 42.23 | 4.4 | 2005 | 6.2 | 42.24 | 0.01 |
| | 3 | 42.23 | 4.3 | 2017 | 6.5 | 42.24 | 0.01 |
| 2 | 1 | 42.24 | 4.4 | 2013 | 6.5 | 42.25 | 0.01 |
| | 2 | 42.24 | 4.3 | 2100 | 6.4 | 42.25 | 0.01 |
| | 3 | 42.24 | 4.4 | 2003 | 6.2 | 42.25 | 0.01 |
| 3 | 1 | 42.26 | 4.5 | 2105 | 6.3 | 42.27 | 0.01 |
| | 2 | 42.26 | 4.6 | 2107 | 6.2 | 42.27 | 0.01 |
| | 3 | 42.26 | 4.6 | 2078 | 6.2 | 42.27 | 0.01 |

It can be seen from table 2 that, the nickel-zinc batteries provided in the examples of the present invention have lower charging and discharging internal resistance and smaller deformation of the electrode.

The nickel-zinc batteries were tested for their fading speed of discharging capacity at 10° C., and the results are shown in table 3, which shows the performance about the fading speed of the capacity for the nickel-zinc batteries provided in the examples of the present invention and the comparative example.

TABLE 3
performance about the fading speed of the capacity for the nickel-zinc
batteries provided in the examples of the present invention and the
comparative example

| | Initial | Cycling | Remained | Cycling | Remained |
|---|---|---|---|---|---|
| | capacity | for 100 | capacity 1 | for 150 | capacity 2 |
| Examples | (mAh) | times (mAh) | (%) | times (mAh) | (%) |
| 1 | 1630 | 1380 | 84.6 | 1260 | 77.3 |
| 2 | 1630 | 1410 | 86.5 | 1300 | 79.7 |
| 3 | 1650 | 1430 | 86.7 | 1350 | 81.8 |
| Compar- | 1600 | 1290 | 80.60 | 1010 | 63.1 |
| ative | | | | | |
| example 1 | | | | | |

It can be seen from table 3 that the nickel-zinc batteries provided by the present invention have lower capacity fading speed.

### Example 7

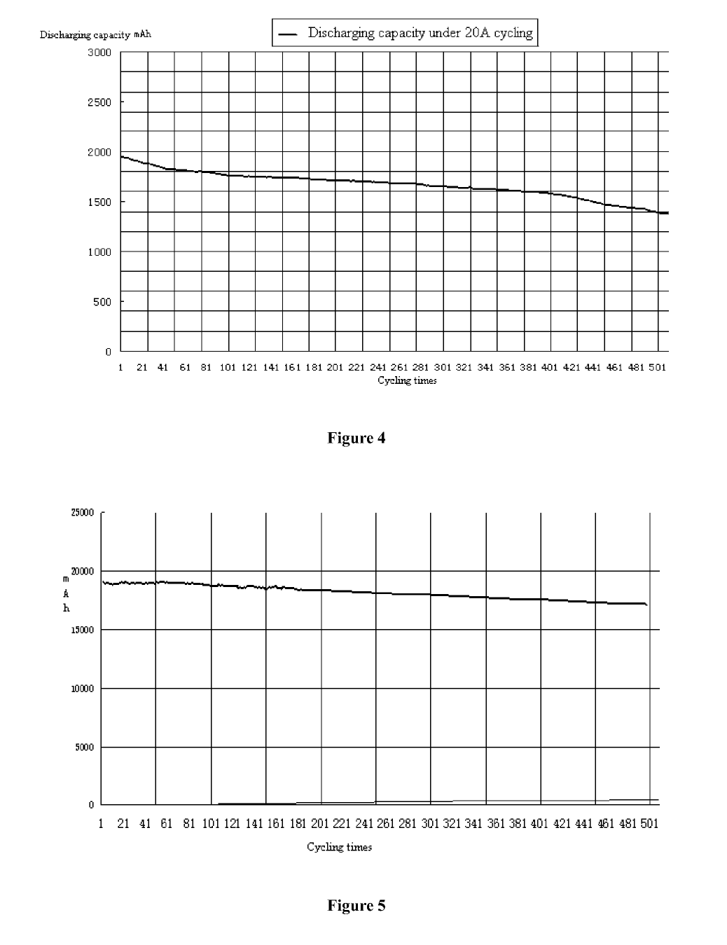

SC1800 mAh nickel-zinc battery was prepared by the method according to example 6 and using the negative electrode prepared in example 3 as the negative electrode, and was tested for the cycling performance under 20A. The results were shown in FIG. 4, which shows the results on the cycling performance test for the nickel-zinc battery provided in example 7. It can be seen from FIG. 4 that the nickel-zinc battery provided by the present invention has longer cycling life.

### Example 8

SC19Ah nickel-zinc battery was prepared by the method according to example 6 and using the negative electrode prepared in example 3 as the negative electrode, and was tested for the cycling performance under 20A. The results were shown in FIG. 5 and table 4, in which FIG. 5 shows the results on the cycling performance test for the nickel-zinc battery provide in example 8 of the present invention, and table 4 shows the results on the cycling capacity fading performance for the nickel-zinc battery provided in example 8.

TABLE 4
cycling capacity fading performance for the nickel-zinc battery
provided in example 8

| Initial capacity | Cycling | Remained capacity | Ratio of the remained |
|---|---|---|---|
| (mAh) | times | (mAh) | capacity (%) |
| 19043 | 50 | 18953 | 99.53 |
| | 100 | 18820 | 98.9 |
| | 150 | 19620 | 97.8 |
| | 200 | 18368 | 96.5 |
| | 250 | 18167 | 95.405 |
| | 300 | 17964 | 94.33 |
| | 350 | 17773 | 93.0 |
| | 400 | 17569 | 92.3 |
| | 450 | 17368 | 91 |
| | 500 | 17196 | 90 |

It can be seen from FIG. 5 and table 4 that the nickel-zinc battery provided in the example of the present invention has good cycling life, and lower capacity fading speed during cycling use.

According to the comparison between the above examples and the comparative example, the nickel-zinc batteries adopting the negative electrode consisted of the active material composition of negative electrode and the substrate of the negative electrode provided by the present invention has the advantages of slow capacity fading speed, long cycling life, stable performance during tests, small internal resistance, and the like.

The description given above is just the preferred embodiments of the present invention. It should be noted that, some improvements and modifications can be made by those skilled in the art without departing from the principle of the present invention, and should be considered as falling in the protection scope of the present invention.

1. A tilted-grid substrate of a negative electrode for a nickel-zinc battery, comprising:
a first zinc foil layer;
a copper foil layer compounded on the first zinc foil layer; and
a second zinc foil layer compounded on the copper foil layer.

2. The tilted-grid substrate of the negative electrode according to claim 1, characterized in that the first zinc foil layer has a thickness of 0.03 mm˜0.07 mm.

3. The tilted-grid substrate of the negative electrode according to claim 1, characterized in that the copper foil layer has a thickness of 0.03 mm˜0.07 mm.

4. The tilted-grid substrate of the negative electrode according to claim 1, characterized in that the second zinc foil layer has a thickness of 0.03 mm˜0.07 mm.

5. The tilted-grid substrate of the negative electrode according to claim 1, characterized in comprising:
a bottom plate for the substrate of the negative electrode;
protrusions symmetrically arranged on two sides of the bottom plate for the substrate of the negative electrode; and
a groove arranged in the middle of the bottom plate for the substrate of the negative electrode.

6. The tilted-grid substrate of the negative electrode according to claim 5, characterized in that the protrusions are formed by folding and flattening the two sides of the bottom plate for the substrate of the negative electrode.

7. An active material composition of a negative electrode for a nickel-zinc battery, comprising:
40 wt %˜60 wt % ZnO;
5 wt %˜10 wt % Zn;
1.5 wt %˜3.5 wt % Zn(OH)₂;
0.5 wt %˜2 wt % Ca(OH)₂;
0.5 wt %˜3 wt % Bi₂O₃;
0.001 wt %˜0.02 wt % In(OH)₂;
20 wt %˜30 wt % binder; and
5 wt %˜10 wt % additive.

8. The active material composition of the negative electrode for the nickel-zinc battery according to claim 7, characterized in that the binder comprises water, polyvinyl alcohol, and hydroxypropyl methyl cellulose by a mass ratio of (90˜95):(3˜5):(2˜5).

9. The active material composition of the negative electrode for the nickel-zinc battery according to claim 7, characterized in that the additive comprises nylon short fibers, polytetrafluoroethylene emulsion, sodium alkyl benzene sulfonate, Na₂HPO₄ and water by a mass ratio of (0.05˜0.3):(3˜7):(0.01˜0.05):(0.1˜0.3):(1˜4).

10. A negative electrode for a nickel-zinc battery, comprising the substrate of the negative electrode according to claim 1, and active material composition of the negative electrode, the active material composition of the negative electrode being coated on the substrate of the negative electrode.

11. The negative electrode for the nickel-zinc battery according to claim 10, characterized in that the negative electrode for the nickel-zinc battery has a cutting surface without being coated with the active material composition of the negative electrode, and a surface symmetric to the cutting surface is soaked by a glue solution comprising Al₂O₃, MgO, polyvinylidene fluoride emulsion, styrene butadiene rubber emulsion, polyvinyl alcohol and water.

12. The negative electrode for the nickel-zinc battery according to claim 10, characterized in that the negative electrode for the nickel-zinc battery has several crossed shallow grooves on the surface of the negative electrode.

13. A method for preparing a negative electrode for a nickel-zinc electrode, comprises the steps of:
pretreating two opposite sides of the substrate of the negative electrode according to claim 1 in Al₂O₃ glue solution, the Al₂O₃ glue solution comprising Al₂O₃, polyvinyl alcohol, and water;
coating the active material composition of the negative electrode claim on the pretreated substrate of the negative electrode, drying and rolling the substrate, and cutting the substrate along a symmetry axis of the two pretreated sides of the substrate to provide a negative electrode semi-finished product; and
soaking a surface symmetrical to the cutting surface of the negative electrode semi-finished products in a glue solution to provide the negative electrode for the nickel-zinc battery, the glue solution comprising Al₂O₃, MgO, Polyvinylidene fluoride emulsion, styrene butadiene rubber emulsion, polyvinyl alcohol, and water.

14. A nickel-zinc battery, comprising the negative electrode for a nickel-zinc battery according to claim 10.

15. A nickel-zinc battery, comprising a nickel-zinc battery prepared by the method according to claim 13.
